(19) United States
(12) Patent Application Publication
(10) Pub. No.: US 2007/0075680 A1
(43) Pub. Date: Apr. 5, 2007

(54) CHARGING MODE CONTROL CIRCUIT

(75) Inventors: Shin-Hong Chung, Shenzhen (CN); Han-Che Wang, Shenzhen (CN); Chun-Wei Pan, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,466

(22) Filed: Aug. 10, 2006

(30) Foreign Application Priority Data
Sep. 30, 2005 (TW) 094134333

(51) Int. Cl. H02J 7/00

(52) U.S. Cl. 320/125

(57) ABSTRACT

A charging mode control circuit (320) includes a detecting circuit (321) and a charging control circuit (322). The detecting circuit detects whether a power/data interface (310) is in a communication state, and accordingly outputting a control signal. The charging control circuit receives the control signal and obtaining power from the power/data interface to charge a secondary battery (330) with a charging mode in accordance with the control signal. The charging mode is a fast charging mode with a charging current larger than a predetermined level, or a slow charging mode with a charging current not larger than the predetermined level. A portable electronic device (30) incorporates the charging mode control circuit is also provided.

### DESCRIPTION

1. Technical Field

The present invention relates to a charging mode control circuit, and particularly to a charging mode control circuit employed in a portable device equipped with a power/data interface.

2. Related Art

Various electronic devices having a USB interface are known heretofore. The USB interface enables not only data communication between two electronic devices, but also the flow of electrical power from one electronic device to another. A portable electronic can be conveniently charged by other electronic devices through the USB interfaces.

However, the USB interfaces define lower-power devices with maximum current consumption of 100 mA and high-power devices with maximum current consumption of 500 mA. With such limited maximum current value (100 mA or 500 mA) of the USB interfaces, it always takes an unduly long time to charge the portable electronic device.

Therefore, there is a need for providing a charging mode control circuit which can solve the above-mentioned problem.

### SUMMARY

A charging mode control circuit is provided in accordance with a preferred embodiment. The charging mode control circuit includes a detecting circuit for detecting whether a power/data interface is in a communication state, and accordingly outputting a control signal; and a charging control circuit for receiving the control signal and obtaining power from the power/data interface to charge a secondary battery with a charging mode in accordance with the control signal. The charging mode is a fast charging mode with a charging current larger than a predetermined level or a slow charging mode with a charging current not larger than the predetermined level.

A portable electronic device is also provided. The portable electronic device includes a secondary battery, a power/data interface, and a charging mode control circuit connected with the power/data interface. The charging mode control circuit further includes: a detecting circuit for detecting whether the power/data interface is in a communication state and accordingly outputting a control signal; and a charging control circuit for receiving the control signal and obtaining power from the power/data interface to charge the secondary battery with a charging mode in accordance with the control signal. The charging mode is a fast charging mode with a charging current larger than a predetermined level or a slow charging mode with a charging current not larger than the predetermined level.

Other advantages and novel features will be drawn from the following detailed description with reference to the attached drawings, in which:

### BRIEF DESCRIPTION OF THE DRAWINGS

FIG. 1 depicts an exemplary block diagram of a charging mode control circuit in accordance with a preferred embodiment of the present invention; and

FIG. 2 depicts an application of the charging mode control circuit of FIG. 1.

### DETAILED DESCRIPTION OF THE EMBODIMENTS

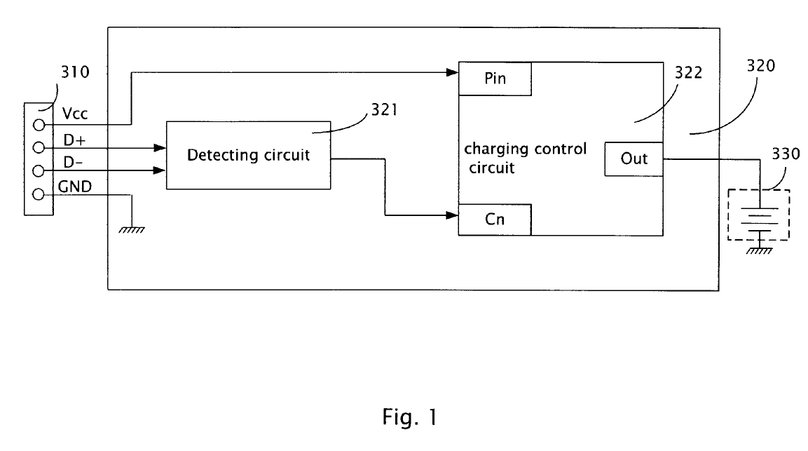

Referring to FIG. 1, an exemplary block diagram of a charging mode control circuit in accordance with a preferred embodiment is shown. The charging mode control circuit 320 is interposed between a secondary battery 330 and a power/data interface 310 such as a universal serial bus (USB) interface, and used to control a charging mode of the secondary battery 330 in accordance with a communication via the power/data interface 310. The power/data interface 310 includes power pins and data pins respectively transferring electrical power and data between two apparatus (or circuits) connected via the power/data interface 310. For clarity, hereinafter employing a USB interface 310 as an example of the power/data interface 310 to illustrate the preferred embodiment.

The charging mode control circuit 320 determines from data pins D+ and D− of the USB interface 310 the type of power source the USB interface 310 connects with. In the preferred embodiment, if the data pins D+ and D− are in use, the charging mode control circuit 320 determines that the USB interface 310 connects with a communication device, such as a computer. The charging mode control circuit 320 then obtains a limited power supply with a current not larger than a predetermined level, such as an amount of 500 mA specified by USB protocols from the communication device, and thereby charges the secondary battery 330 with a slow charging mode. If the data pins D+ and D− are “idle”, the charging mode control circuit 320 determines that the USB interface 310 connects with an adapter. The charging mode control circuit 320 obtains a high power supply with a current larger than the predetermined level (500 mA) from the adapter, and thereby charges the secondary battery 330 with a fast charging mode.

The charging mode control circuit 320 includes a detecting circuit 321 and a charging control circuit 322. The detecting circuit 321 connects with the data pins D+ and D− to detect whether a communication occurs between two apparatus via the USB interface 310. If the communication occurs, the detecting circuit 321 transmits a slow charging mode control signal to the charging control circuit 322, otherwise, the detecting circuit 321 transmits a fast charging mode control signal to the charging control circuit 322. The charging control circuit 322 includes a plurality of ports, of which, a first port is a power-in port Pin, a second port is a control port Cn, and a third port is a power-out port Out.

The Power-in port Pin connects with a power pin Vcc of the USB interface 310 and receives power from a communication device or an adapter via the power pin Vcc. The control port Cn connects with the detecting circuit 321. When receiving a slow charging mode control signal via the control port Cn, the charging control circuit 322 utilizes a slow charging mode to charge the secondary battery 330. The charging control circuit 322 outputs a small amount of current to the secondary battery 330 via the power-out port Out. The small amount of current is not larger than 500 mA the USB protocols specified. On the contrary, when receiving a fast charging mode control signal via the control port Cn, the charging control circuit 322 utilizes a fast charging mode to charge the secondary battery 330. The charging control circuit 322 outputs a large amount of current which larger than 500 mA to the secondary battery 330 via the power-out port Out.

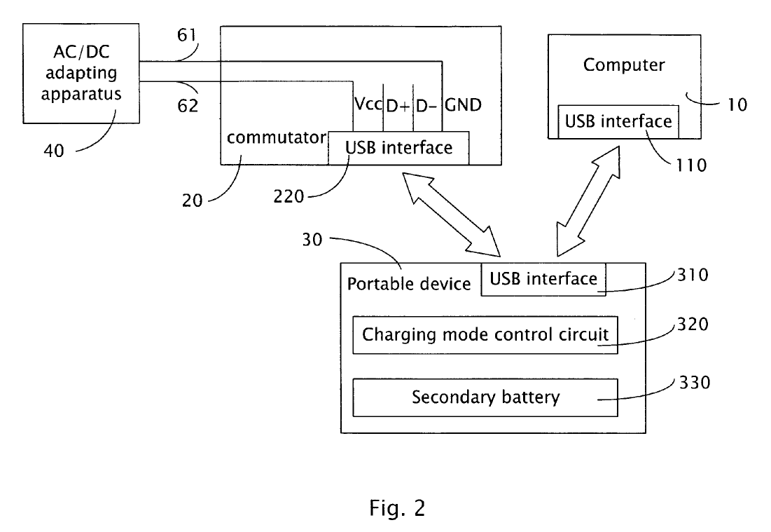

Referring to FIG. 2, an application of the charging mode control circuit 320 is shown. In this application, the charging mode control circuit 320, the USB interface 310 and the secondary battery 330, are all integrated into a portable electronic device 30. Through the USB interface 310, the portable electronic device 30 may connect to any other USB device, such as a computer 10 equipped with a USB interface 110. The portable electronic device 30 communicates with the computer 10 via the USB interface 310. The charging mode control circuit 320 determines that the USB interface 310 is in a communication state and accordingly charges the secondary battery 330 with a slow charge mode. The portable electronic device 30 may connect to an AC/DC (alternating current/direct current) adapter 40 via the USB interface 310. The AC/DC adapter 40 may equipped with a USB interface itself or as shown in FIG. 2, may connects with a commutator 20 equipped with a USB interface 220. The power pins Vcc and GND of the USB interface 220 connects with the AC/DC adapter 40 respectively via two electrical wires 61 and 62, and the data pins D+ and D− of the USB interface 220 are “idled”. The USB interface 220 just acts as conducting wires and is only used to conduct electrical power. The charging mode control circuit 320 determines that the USB interface 310 is in a non-communication state and accordingly charges the secondary battery 330 with the fast charging mode.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A charging mode control circuit, comprising:
a detecting circuit for detecting whether a power/data interface is in a communication state, and accordingly outputting a control signal; and
a charging control circuit for receiving the control signal and obtaining power from the power/data interface to charge a secondary battery with a charging mode in accordance with the control signal, the charging mode being a fast charging mode with a charging current larger than a predetermined level or being a slow charging mode with a charging current not larger than the predetermined level.

2. The charging mode control circuit as claimed in claim 1, wherein when the detecting circuit detects the power/data interface is in the communication state, the charging control circuit charges the secondary battery with the slow charging mode.

3. The charging mode control circuit as claimed in claim 2, wherein when the detecting circuit detects the power/data interface is in a non-communication state, the charging control circuit charges the secondary battery with the fast charging mode.

4. The charging mode control circuit as claimed in claim 3, wherein the power/data interface connects with a communication device or an adapter.

5. The charging mode control circuit as claimed in claim 4, wherein when connecting with the communication device, the power/data interface obtains power supply with a current not larger than the predetermined level from the communication device as well as communicating with the communication device.

6. The charging mode control circuit as claimed in claim 5, wherein when connecting with the adapter, the power/data interface obtains power supply with a current larger than the predetermined level from the adapter.

7. The charging mode control circuit as claimed in claim 6, wherein the power/data interface acts as conducting wires when connecting with the adapter.

8. The charging mode control circuit as claimed in claim 1, wherein the power/data interface is a universal serial interface.

9. A portable electronic device, comprising:
a secondary battery;
a power/data interface; and
a charging mode control circuit connected with the power/data interface and comprising:
a detecting circuit for detecting whether the power/data interface is in a communication state and accordingly outputting a control signal; and
a charging control circuit for receiving the control signal and obtaining power from the power/data interface to charge the secondary battery with a charging mode in accordance with the control signal, the charging mode being a fast charging mode with a charging current larger than a predetermined level or being a slow charging mode with a charging current no more than the predetermined level.

10. The portable electronic device as claimed in claim 9, wherein the power/data interface connects with an apparatus equipped with a power/data interface, the apparatus being a communication device or an adapter.

11. The portable electronic device as claimed in claim 10, wherein when the apparatus is the communication device, the charging mode control circuit charges the secondary battery with the slow charging mode.

12. The charging mode control circuit as claimed in claim 11, wherein when the apparatus is the adapter, the charging mode control circuit charges the secondary battery with the fast charging mode.

13. The charging mode control circuit as claimed in claim 12, wherein the power/data interface acts as conducting wires when connecting with the adapter.

14. The charging mode control circuit as claimed in claim 9, wherein the power/data interface is a universal serial interface.
